(19) United States
(12) Patent Application Publication
(10) Pub. No.: US 2004/0085991 A1
(43) Pub. Date: May 6, 2004

(54) Method for the allocation of access in a partially connected network

(75) Inventor: Francois Paul, Le Plessis Bouchard (FR)

Correspondence Address: LOWE HAUPTMAN GILMAN & BERNER, LLP, Suite 310, 1700 Diagonal Road, ALEXANDRIA, VA, 22314, US

(73) Assignee: THALES

(21) Appl. No.: 10/694,765

(22) Filed: Oct. 29, 2003

(30) Foreign Application Priority Data
Oct. 31, 2002 (FR) 02 13703

(51) Int. Cl. H04B 7/212

(52) U.S. Cl. 370/442

(57) ABSTRACT

A method for the allocation of resources in a communications system comprising several stations including defining a graph of competition between the different stations, and assigning time intervals to each station in making successive passages on all the stations and carrying out, at each passage and for each station, wherein E is an interval of given time interval numbers, and n is the smallest natural integer that does not belong to the interval E. If it is not the first passage AND if n>Nmax, then no time interval whatsoever is added to the station Si. If it is the first passage OR if n=<Nmax, then n is added to the time intervals assigned to Si. These steps are executed so long as a time interval is added.

### BACKGROUND OF THE INVENTION 1. Field of the Invention

The present invention relates to a method for the allocation of access by stations to a partially connected network.

In the present description, the expression “partially connected” designates a network formed by several stations where the links are not necessarily set up between all the possible pairs of stations, and where the links are not necessarily symmetrical. For example, when a station makes transmission, certain stations but not all of them receive signals.

2. Description of the Prior Art

The mechanisms currently used for the allocation of access by stations to a broadcasting medium, for example radio, are based either on preliminary scheduling, such as that of the TDMA (Time Division Multiple Access) protocol or again on scheduling that is computed independently by each station accessing the medium, with the introduction of random components and feedback so as to reduce the effect of collisions (examples are the “slotted Aloha” algorithm and the matching of probability of access).

Preliminary scheduling (TDMA) has the advantage wherein each station is guaranteed a minimum time of access to the network and a minimum proportion of use of the medium. However, it has the drawback of not adapting this allocation to the effective needs of each station, these needs being possibly variable in time. There may therefore be a disproportion between the performance that the broadcasting medium is capable of giving and the performance that is actually obtained.

Scheduling algorithms with adaptation, which are computed independently on each station, have the advantage of adapting to the effective use of the medium by the different stations. However, their specifications make systematic use of the deliberate introduction of random phenomena and of feedback mechanisms between the different stations. The state variables of the algorithms on a station vary as a function of the behavior of the other stations. Furthermore, these algorithms do not claim to eliminate collisions. They take them into account in their operations so as to reduce their frequency.

The present invention proposes especially a method that can be used comprehensively to ensure access for all the stations to the broadcasting medium during a substantial proportion of time.

### SUMMARY OF THE INVENTION

The invention relates to a method for the allocation of resources in a communications system comprising several stations, at least two of which are not within range of visibility. The method comprises the following steps:

defining a graph of competition between the different stations,

assigning time intervals to each station in making successive passages on all the stations and carrying out, at each passage and for each station, the following steps:

E is an interval of given time interval numbers

n is the smallest natural integer that does not belong to the interval E,

(A.1) If it is not the first passage AND if n>Nmax, then no time interval whatsoever is added to the station Si,

(A.2) if it is the first passage OR if n=<Nmax, then n is added to the time intervals assigned to Si.

(B) the loop of the passages is continued on all the stations:

(B.1) if, during a passage, no time interval has been added to any station, then no other passage is made,

(B.2) if, during a passage, at least one time interval has been added, then a new passage is executed.

The method according to the invention makes it possible especially to ensure a certain proportion of use of the broadcasting medium as a function of the topology of the network, in preventing collisions during access to the broadcasting medium.

### BRIEF DESCRIPTION OF THE DRAWINGS

Other features and advantages of the invention shall appear more clearly from the following description of an exemplary embodiment given by way of an illustration that in no way restricts the scope of the invention and from the appended figures of which:

FIGS. 1 and 2 show a quantitative example of a topology graph enabling the execution of the method according to the invention, FIG. 3 shows an exemplary network architecture of several stations,

### MORE DETAILED DESCRIPTION

For a clearer understanding of the steps implemented in the method, the example given by way of an illustration that in no way restricts the scope of the invention relates to a radio network comprising several stations, such as transmitters-receivers or transceivers. The links between the stations are not all symmetrical, for example S_{A} receives from S_{B} but S_{B} does not receive from S_{A} and S_{A} receives from S_{c} and S_{c} receives from S_{A}.

The principle implemented is the following:

It is assumed that an external entity ensure that, at all times, each station Si of the radio network knows the full topology of the network. On the basis of this information, according to the method a transmission schedule is determined for each station. This schedule gives each station a precise indication of the time intervals at which the station is entitled to make transmission. When a station wishes to make transmission and is located in a time interval authorized for itself, then it applies a mechanism for the allocation of the broadcasting medium. The algorithm for computing this schedule takes account especially of the fact that certain groups of stations are completely connected and may therefore share permitted transmission time intervals. Indeed, should several stations be within range of visibility of each other and should they simultaneously attempt access to the broadcasting medium, the access to the medium will be adjudged by means of the allocation mechanism of the invention.

It is furthermore assumed that the stations Si have a common time base that divides the time into intervals, numbered from 0, called “transmission intervals” that are equal intervals for example. In principle, it should be possible for a data transmission to be entirely contained within a transmission interval. The time base is provided by clocks with which each station is equipped. These clocks are synchronized with each other The method of allocation according to the invention comprises, in brief, the following steps:

Defining a topology of the network, for example in the form of a relationship of “visibility” between the stations, expressing the fact that a certain station can receive from a certain other station,

Determining a graph of another relationship known as a relationship of “competition” from the relationship of “visibility”—it is said that two stations are in a relationship of “competition” if the stations are not in relationship of “visibility” but are each seen by a third station, or again if the relationship of visibility between these two stations is not symmetrical, i.e. if one station receives from the other but not vice versa.

For each station, defining the time slots in which it can make transmission.

The steps of the allocation algorithm are especially the following:

### Step I

The system gives the mechanism (for example through an external device or else the device integrated with the stations) information on the visibility of the network. More specifically, the following relationship is defined: let us take two stations Si and Sj. It is said that Si receives from Sj, and SiRSj is written if and only if Si receives when Sj transmits. The system gives the graph of this relationship. Here below, this graph is called the “graph of visibility” Gv.

### Step II—the Graph of Visibility Being Known

### Step II.1 Building the Graph of a New Relationship Called a Relationship of <<Competition>>

From the relationship of visibility (graph Gv), a relationship of competition between stations, referenced C, is defined.

Thus two stations Si and Sj are in competition. SiCSj if and only if

(SiRSj and (NOT SjRSi))

or

(SjRSi and (NOT SiRSj))

or

(∃ Sk such that SkRSi AND SkRSj AND NOT (SiRSj and SjRSi))

In other words, SiCSj if and only if there is an asymmetrical relationship of visibility between the two stations or else a third station receives from these two stations, but there is no symmetrical relationship of visibility between the two stations Si and Sj.

Step II.2 Assignment of Time Interval Numbers to Each Station

Then, time interval numbers are assigned to each station. Each station can have several time interval numbers assigned to it. This assigning can be done especially by scanning the full list of stations several times in the order of their identification numbers.

At each passage, according to the method, each station Si is examined and, if necessary, a time interval number is added to it, in applying the rules given here below. At the end of each passage, according to the method, the maximum time interval number Nmax that has been assigned during this and the preceding passages is noted.

The following are the rules applied for each of the stations Sᵢ examined during each passage:

considering the set E of time interval numbers that is a combination of the time interval numbers already assigned to a station Si during preceding passages and time interval numbers already assigned to the stations Sj such as SiCSj (namely the stations with which Si is in competition). During the first passage, E may be empty,

taking n to be the smallest natural integer not belonging to the interval E,

A.1) If it is not the first passage AND if n>Nmax then, according to the invention, no time interval whatsoever is added to the station Si,

(A.2) if it is the first passage OR if n=<Nmax then, according to the invention, n is added to the time intervals assigned to Si.

The following are the rules applied at the end of a passage, when all the stations have been examined during this passage:

(B.1) if, during a passage, the method does not entail the adding of a time interval any station then, according to the method, no other passage is executed.

(B.2) if, during a passage, the method entails the adding of at least one time interval then, according to the invention, a new passage is executed.

At the end of the last passage, the scheduling is defined as follows:

Its periodicity corresponds to Nmax+1 transmission intervals,

Inside each period thus defined (namely inside each succession of Nmax+1 consecutive transmission intervals), the transmission intervals are numbered in the order 0 to Nmax. Each station is entitled to make transmission during the intervals that were assigned to it to during the passages described here above.

When a station decides to make transmission during a transmission interval for which it is authorized, then it must do so in complying with the medium allocation mechanism described for the below.

### Quantitative Example of the Implementation of the Method of Assigning Transmission Intervals According to the Invention

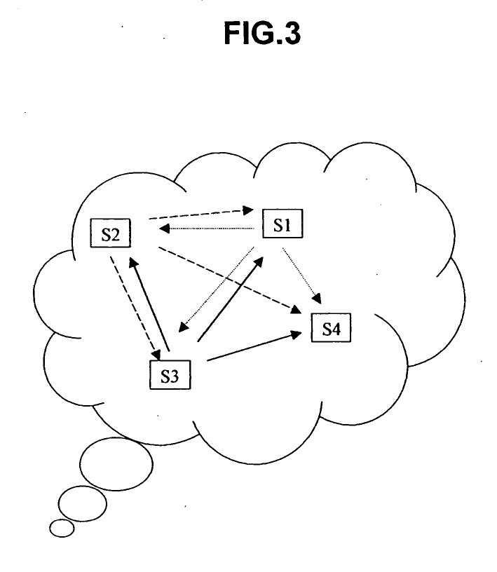

FIGS. 2 and 3 illustrate an exemplary implementation of the method according to the invention.

The topology of the network is illustrated in FIG. 2. It is given in the form of a relationship existing between the stations. The stations that are within range of visibility of each other are directly connected by lines in the figure.

FIG. 3 shows the graph of competition deduced
from the figure which can be read as follows:

| | |
|---|---|
| Station | Relationships of competition |

| | | | | |
|---|---|---|---|---|
| 1 | S1 [symbol] S6 | S1 [symbol] S7 | | |
| 2 | S2 [symbol] S6 | S2 [symbol] S7 | | |
| 3 | S3 [symbol] S8 | S3 [symbol] S9 | | |
| 4 | S4 [symbol] S7 | S4 [symbol] S8 | | |
| 5 | S5 [symbol] S6 | S5 [symbol] S7 | | |
| 6 | S6 [symbol] S1 | S6 [symbol] S2 | S6 [symbol] S5 | S6 [symbol] S9 |
| 7 | S7 [symbol] S1 | S7 [symbol] S2 | S7 [symbol] S4 | S7 [symbol] S5 |
| 8 | S8 [symbol] S3 | S8 [symbol] S4 | | |
| 9 | S9 [symbol] S3 | S9 [symbol] S6 | | |

The transmission intervals are assigned as follows, and the development is given by means of a detailed description of certain steps of the second passage by way of an illustration.

First Passage

During the first passage, the set E is vacant, and the smallest greater integer is therefore equal to 0

Second Passage

Station 1 E={0, 1}n=2, n=<Nmax, the condition (A.2) can be applied:

Hence 2 is assigned as the interval number to the station,

Station 2 in competition with the stations 6 and 7, E={0, 1}, n=2 n=<Nmax, the condition (A.2) can be applied: hence number 2 is assigned to the station,

Station 3 in competition with the stations 8 and 9−E={0, 1, 2}, n=3 n>Nmax, the condition (A.1) can be applied: hence no transmission interval is assigned to the station,

. . .

Station 5 in competition with 6 and 7−E={0, 1}, n=2 n=<Nmax, the condition (A.2) therefore applies and 2 is assigned as a slot number to the station,

Station 6 in competition with 1, 2, 5 and 9−E={0, 1, 2}, n=3 n>Nmax, the condition (A.1) is applied and no time interval is added to the station,

. . .

up to the station 9

Third passage

During the second passage, according the method, at least one time interval has been added, and the condition (B.2) applies. According to the method, a third passage is executed during which no slot is added. The condition (B.1) therefore applies and the method terminates its execution-condition (B1).

The table 2 for the assignment of the time slots given here below.

| | Transmission interval | Transmission interval |
|---|---|---|
| | number assigned during | number assigned during |
| Station number | the first passage | the second passage |
| 1 | 0 | 2 |
| 2 | 0 | 2 |
| 3 | 0 | No assignment |
| 4 | 0 | 2 |
| 5 | 0 | 2 |
| 6 | 1 | No assignment |
| 7 | 1 | No assignment |
| 8 | 1 | No assignment |
| 9 | 2 | No assignment |

The following other time interval is assigned to the stations:

The stations 1, 2, 4 and 5 are entitled to transmit at the intervals 0 and 2,

The station 3 is entitled to transmit at the interval 0,

The stations 6, 7 and 8 are entitled to transmit at the interval 1,

The station 9 is entitled to transmit at the interval 2.

Nmax=2, the periodicity of the scheduling is defined in therefore equal to 3. This means that the transmission intervals are combined in sequences of three consecutive intervals and that, within each of these sequences, the transmission intervals authorized for each station are those indicated in the above table.

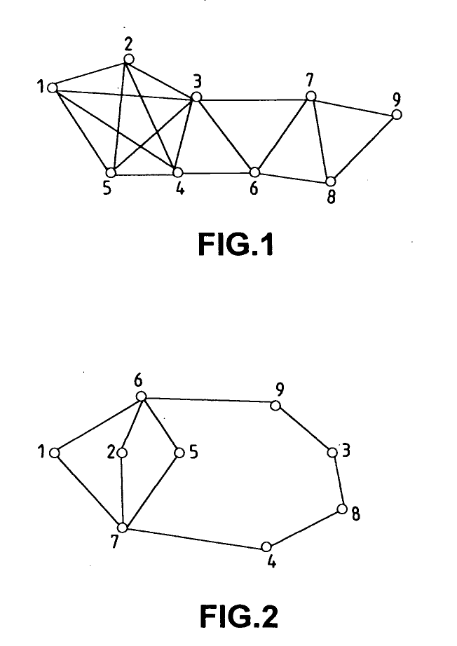

According to an alternative embodiment, the method may comprise several complementary steps enabling especially an allocation of access to the broadcasting medium, in such a way that when several stations in a relationship of visibility are entitled to transmit during the same transmission interval, only one of them effectively allocates the medium to itself, thus preventing any collision. FIG. 1 gives a diagrammatic view of an exemplary network formed by stations in visible range of one another.

In brief, the principle of operation is the following: when several stations wish to access the radio network, they initiate an allocation sequence. During this sequence, all the stations Si simultaneously announce their identification, following a precise protocol that is the object of the invention. At the end of this allocation sequence, the station Se that has announced the greatest number is deemed have allocated the radio network to itself, i.e. it uses the network. The other stations Sj know that they are not chosen. Once the chosen station Se has finished using the radio network, the other stations repeat the steps of the method if they wish to allocate the radio network to themselves, i.e. if they wish to become the chosen station. So as not to favor any station, the identifications are routinely permutated.

FIG. 1 represents a radio network structure comprising several stations Si. The radio network is in a state of broadcasting: this is expressed by the fact that when a station Si transmits a signal containing a piece of information or a message, all the other stations know that a message or a piece of information has been sent.

The stations Si are adapted so that:

if several stations are transmitting simultaneously, then all the other stations are capable of determining the fact that at least one of the stations has sent out a piece of information, even if the contents of the information cannot be extracted (for example in the event of a scrambling of the information sent). For this purpose, the stations possess, for example, a computer programmed accordingly.

The stations Si have a common time base that divides the time into elementary intervals, for example equal intervals, hereinafter called “identification slots” referenced k. These identification slots are numbered from 0 with a reference known to all the stations. A periodic resetting of this reference at zero is possible. The duration of this periodic interval is set, for example, so as to preserve an equitable character for the algorithm implemented in the method according to the invention. The time base is, for example, provided by clocks with which each station is equipped. These clocks are synchronized with each other.

The method defines especially two types of elementary operations:

the “receive” operation: that is, for a station Si, detecting whether another station Sm is transmitting something, for example a message, during the slot k. If the station Si, when it is in a state of reception, detects a signal sent out by a station Sj, then it is said to receive the symbol “1”; if not it is said to receive the symbol “0”.

the “transmit 1” operation: the station Si transmits any signal during the slot k. The contents of the transmitted signal are not taken into account for the definition of this operation.

The method according to the invention comprises at least the following steps:

a) Assigning an Initial Identification to Each Station Si.

This corresponds to assigning an identification number I₀ to a station, this identification number being encoded on a given number of bits n whose value is taken in a predefined interval of integers [0, N−1], such that N=2ⁿ. The initial identifications of the stations Si are different.

This assigning is done for example by a system of management and configuration external to the stations and known to those skilled in the art.

At each new time interval corresponding to an identification slot k, the current identification I of the station Si is computed by the station as a function of the initial value I⁰ and the current value of k. An exemplary method for the computation of I as a function of I⁰ and k is given further below. This computation is made, for example, by means of a digital processing circuit, such as a processor or an ASIC, integrated into the station.

b) Attempt at Transmission

A station Si that wishes to have the radio network allocated to it (i.e. wishes to use the network) starts a sequence to announce its identification. At this time, its identification number has a given value 1, written as follows in binary mode: b₁b₂ . . . bₙ₋₁, bₙ. The announcing sequence comprises especially the following steps:

b.1) for i as a variant of 1 to n, i being the index of b,

b.1.1) if bi is equal to “0”, the station Si is in a state of reception during the slot k+i−1,

if the station receives the symbol “1”, it is not chosen. It aborts its allocation sequence (i.e. it makes an attempt to send) since the radio network will be allocated to another station Se. The station Si no longer transmits in the following slots, until the chosen station referenced Se has finished using the radio network.

If the station receives the symbol “0”, (state of reception), it continues the loop b.1).

b.1.2) If bi is equal to “1”, the station Si is in a transmission state; it transmits the symbol “1” during the slot k+i−1.

b.2) if the station has performed the steps of the loop b.1) without receiving the symbol <<1>>, then it is declared to be the chosen station Se.

c) At the end of the allocation sequence, the radio network is allocated to the station Se, while the other stations Sj wait for this chosen station Se to finish using the radio network. To this end, the stations of the network are equipped for example with a computer using a detection algorithm known, for example, to those skilled in the art.

According to one alternative embodiment, an additional step b0) is added before the step b1). This step b0) consists in transmitting during the slot k. The steps b1); b..1.1) and b.1.2) are performed during the slots k+1 to k+n, instead of the slots k to k+n−1.

So long as a station is in a state of reception, it can detect the start of an allocation sequence initiated by one or more other stations because such a start takes the form of the transmission of a symbol “1”. Several stations may start an allocation sequence simultaneously, and the loop b2) serves to make a choice among them for assigning access to the medium.

### Exemplary Method for Assigning the Current Identification I as a Function of th Initial Identification I₀ and of the Current Value of k

This assigning is done, for example, as follows. For any value of N, the algorithm (this is the algorithm for the computation of I as a function of I₀k) is given a piece of configuration data in the form, for example, of a permutation a of the interval [0, n−1]. The permutation has only one cycle with the length N.

As mentioned earlier, a station is assigned an initial identification I₀ in an interval [0, N−1]. During the allocation sequence that starts at the slot k, the identification used is a ₖ(I₀).

The value of C is chosen in such a way that its successive iterations, applied to any initial subset of the interval [0, N−1], favor none of the initial elements.

An exemplary permutation on the interval [0, 31] is given in the following table 1 by way of an illustration:

| I | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| σ (i) | 14 | 27 | 4 | 19 | 28 | 30 | 16 | 5 | 17 | 24 | 2 | 25 | 18 | 23 | 31 | 21 |
| I | 16 | 17 | 18 | 19 | 20 | 21 | 22 | 23 | 24 | 25 | 26 | 27 | 28 | 29 | 30 | 31 |
| σ (i) | 8 | 3 | 0 | 26 | 11 | 10 | 6 | 12 | 29 | 13 | 9 | 22 | 20 | 15 | 1 | 7 |

### Exemplary Implementation of the Method

The following example is given for a radio network with four stations present.

Let it be assumed that:

N=32

Four stations A, B, C and D are present in the radio network, and their initial identifications are respectively 11,12, 13 and 22.

The permutation a chosen in the implementation is the one given in the table 3 as an example here above.

We consider only cases where the stations start allocation sequences simultaneously. For each station, the symbol “↑1” is used to indicate the operation “send 1” and the symbols “↓0” and “↓1” indicate the operations “receive 0” and “receive 1”.

Let us assume that an allocation sequence starts with the identification slot k=3827. k modulo 32=19: the iteration of the permutation is therefore σ³⁸²⁷=σ¹⁹. The values of identification of the stations A, B, C and D are therefore respectively σ¹⁹(11)=3, σ¹⁹(12)=24, σ¹⁹ (13)=26 and σ¹⁹ (22)=25. The corresponding binary representations are A: 00011, B: 11000, C:11010 and D:11001.

Table 2 here below gives a bit-by-bit breakdown of the binary representation of the identification of the stations:

TABLE 2

| | b1 | b2 | b3 | B4 | b5 |
|---|---|---|---|---|---|
| A | 0 | 0 | 0 | 1 | 1 |
| B | 1 | 1 | 0 | 0 | 0 |
| C | 1 | 1 | 0 | 1 | 0 |
| D | 1 | 1 | 0 | 0 | 1 |

The behavior of the stations will then be:

| Slot | K | k + 1 | k + 2 | k + 3 | k + 4 | k + 5 |
|---|---|---|---|---|---|---|
| A: | ↑1 | ↓1 | ↓1 | ↓0 | ↓1 | ↓0 |
| | | abort | | | | |
| B: | ↑1 | ↑1 | ↑1 | ↓0 | ↓1 | ↓0 |
| | | | | | abort | |
| C: | ↑1 | ↑1 | ↑1 | ↓0 | ↑1 | ↓0 |
| D: | ↑1 | ↑1 | ↑1 | ↓0 | ↓1 | ↓0 |
| | | | | | abort | |

The station C is chosen because it never receives the transmission symbol << 1 >>.

The steps of the method of access allocation described here above are used for example in the case of a radio network comprising several transmitter-receiver units provided with digital processing circuits, such as an ASIC programmed to execute the steps described here above or again a programmed processor.

The “activity” of a unit is detected, for example, by the detection of levels. For example, the operation “send 1” corresponds to the transmission of a noise. Thus, scrambling between the stations will not result in a diminishing of the level received.

The method according to the invention can also be applied to a local area network provided with computer devices such as microcomputers.

What is claimed is:

1. A method for the allocation of resources in a communications system comprising several stations, at least two of which are not within range of visibility, the method comprising the following steps:
defining a graph of competition between the different stations; assigning time intervals to each station in making successive passages on all the stations and carrying out the following steps at each passage and for each station:
E is an interval of given time interval numbers;
n is the smallest natural integer that does not belong to the interval E;
if it is not the first passage AND if n>Nmax, then no time interval whatsoever is added to the station Si;
if it is the first passage OR if n=<Nmax, then n is added to the time intervals assigned to Si;
the loop of the passages is continued on all the stations:
if, during a passage, no time interval has been added to any station, then no other passage is made;
if, during a passage, at least one time interval has been added, then a new passage is executed.

2. The method according to claim 1, wherein the interval E corresponds to a combination of the time interval numbers already assigned to a station Si during preceding passages and time intervals already assigned to the stations Sj which are related to Si by a particular relationship known as a relationship of competition.

3. The method according to claim 1, wherein the graph of the relationship of competition is set up according to the following steps: from a relationship of visibility written as R, a relationship of competition between stations, referenced C, is determined as follows:
two stations Si and Sj are in competition, SiCSj if and only if
(SiRSj and (NOT SjRSi))
or
(SjRSi and (NOT SiRSj))
or
(∃ Sk such that SkRSi AND SkRSj AND NOT (SiRSj and SjRSi))

4. The method according to claim 1, further comprising the following steps:
a) encoding the identifier I of each of the stations, on a number n of bits b1, b2, . . . bn, using two symbols corresponding respectively to a reception state and to a transmission state;
b) for any unspecified station Si, during an attempt to make transmission, starting at a given identification slot; b.1) for i varying from 1 to n, b.1.1) if the value of bi is equal to the symbol corresponding to the reception state, the station Si receives during the slot k+i−1:
if the station Si detects a signal sent by another station it considers itself not to be chosen;
if the station Si detects nothing, the station Si continues to scan the bits bi,
b.1.2) if the value of bi is equal to the symbol corresponding to the transmission state, the station transmits during the slot k+i −1;
c) allocating the medium to the station that has performed the step b.2) without receiving the transmission symbol.

5. The method according to claim 4, comprising a step b.0) preliminary to the step b.1) for the transmission of the transmission symbol by the station Si and wherein the steps b.1), b..1.1), b.1.2) may be carried out on identification slots varying from k +1 to k+n.

6. The method according to claim 4 using binary encoding and the reception operation “receive 1” when a station detects a signal coming from another station and “receive 0” when it receives no signal and the “send 1” operation when the station transmits a signal in a given slot.

7. The method according to claim 4, using an identification number taken in an interval [0, N−1] with N=2ⁿ.

8. The method according to claim 1, wherein the broadcasting medium is a radio station and wherein the stations are transmitter-receiver units.

9. A method for the allocation of access to a broadcasting medium by several stations Si, wherein the stations are provided with a digital processing circuit adapted to executing the steps of a method comprising the following steps:
defining a graph of competition between the different stations;
assigning time intervals to each station in making successive passages on all the stations and carrying out the following steps at each passage and for each station:
E is an interval of given time interval numbers
n is the smallest natural integer that does not belong to the interval E,
if it is not the first passage AND if n>Nmax, then no time interval whatsoever is added to the station Si;
if it is the first passage OR if n=<Nmax, then n is added to the time intervals assigned to Si;
the loop of the passages is continued on all the stations:
if, during a passage, no time interval has been added to any station, then no other passage is made;
if, during a passage, at least one time interval has been added, then a new passage is executed.

10. The method according to claim 9 wherein the interval E corresponds to a combination of the time interval numbers already assigned to a station Si during preceding passages and time intervals already assigned to the stations Sj which are related to Si by a particular relationship known as a relationship of competition.

11. The method according to claim 9 wherein the graph of the relationship of competition is set up according to the following steps:
from a relationship of visibility written as R, a relationship of competition between stations, referenced C, is determined as follows:
two stations Si and Sj are in competition, SiCSj if and only if
(SiRSj and (NOT SjRSi))
or
(SjRSi and (NOT SiRSj))
or
(∃ Sk such that SkRSi AND SkRSj AND NOT (SiRSj and SjRSi))

12. The method according to claim 9 wherein the digital processing circuit is adapted for executing the following steps:
a) encoding the identifier I of each of the stations, on a number n of bits b1, b2, . . . bn, using two symbols corresponding respectively to a reception state and to a transmission state;
b) for any unspecified station Si, during an attempt to make transmission, starting at a given identification slot, b.1) for i varying from 1 to n, b.1.1) if the value of bi is equal to the symbol corresponding to the reception state, the station Si receives during the slot k+i−1:
if the station Si detects a signal sent by another station it considers itself not to be chosen;
if the station Si detects nothing, it continues to scan the bits bi b.1.2) if the value of bi is equal to the symbol corresponding to the transmission state, the station transmits during the slot k+i −1;
c) allocating the medium to the station that has performed the step b.2) without receiving the transmission symbol.

13. The method according to claim 12 wherein it comprises a step b.0) preliminary to the step b.1) for the transmission of the transmission symbol by the station Si and wherein the steps b.1), b.1.1), b.1.2) may be carried out on identification slots varying from k +1 to k+n.

14. The method according to claim 12 using binary encoding and the reception operation “receive 1” when a station detects a signal coming from another station and “receive 0” when it receives no signal and the “send 1” operation when the station transmits a signal in a given slot.

15. The method according to claim 9 wherein the broadcasting medium is a radio station and wherein the stations are transmitter-receiver units.

16. The method according to claim 9 comprising a station configuration device that is separate from the stations.

17. The method according to claim 5, using binary encoding and the reception operation “receive 1” when a station detects a signal coming from another station and “receive 0” when it receives no signal and the “send 1” operation when the station transmits a signal in a given slot.

18. The method of claim 13, using binary encoding and the reception operation “receive 1” when a station detects a signal coming from another station and “receive 0” when it receives no signal and the “send 1” operation when the station transmits a signal in a given slot.
